(19) United States
(12) Patent Application Publication
(10) Pub. No.: US 2006/0188627 A1
(43) Pub. Date: Aug. 24, 2006

(54) Isomaltulose or trehalose containing comestibles for sustained carbohydrate energy release and increased fat oxidation

(76) Inventors: Fredericus Johannes Petrus Henricus Brouns, Sibbe-Valkenburg (NL); Jacques Georges Denis Cenere Simon, Clamart (FR)

Correspondence Address: FITCH, EVEN, TABIN & FLANNERY, P. O. BOX 65973, WASHINGTON, DC, 20035, US

(21) Appl. No.: 10/565,367

(22) PCT Filed: Jul. 16, 2004
(86) PCT No.: PCT/EP04/07901

§ 371 Date: Jan. 23, 2006

(30) Foreign Application Priority Data
Jul. 23, 2003 (EP) 03254637.6
Jul. 23, 2003 (EP) 03254636.8

(51) Int. Cl. A23L 1/236

(52) U.S. Cl. 426/548

(57) ABSTRACT

The current invention relates to a dry composition comprising isomaltulose, at least a polyol and a carbohydrate selected from the group consisting of fructose, sucrose, invert sugar, and mixtures thereof. This composition is applied in solid, semi-solid and liquid comestibles. Furthermore, isomaltulose, trehalose or mixtures thereof are used in food to induce fat oxidation.

### TECHNICAL FIELD

The present invention relates to the use of isomaltulose and/or trehalose for sustained carbohydrate energy release and increased fat oxidation in liquid, semi-solid and solid comestibles.

### BACKGROUND OF INVENTION

There are a number of liquid, semi-solid and solid products currently applied for providing energy to the body.

A lot of liquid compositions or diluted mixtures are on the market by the name of ‘Activity drinks’, ‘Sports drinks’, ‘Energy drinks’ or ‘Nutrient drinks’. These drinks are reported to meet requirements with respect to the use and/or loss of carbohydrates, electrolytes, vitamins, electrolytes, amino acids, and other important nutrients which occurs during heavy exercise.

JP01-060360A (abstract) relates to an isotonic drink which is containing palatinose (=isomaltulose) as main carbohydrates.

JP63-112963A (abstract) relates to food and drink which is containing palatinose as a sweetener, and/or excipient, and/or extender.

U.S. Pat. No. 4,554,429 describes a low-cariogenic sweetener comprising sucrose and palatinose. Different ratios of sucrose to palatinose in different food applications are disclosed.

JP 1989-0174093 (abstract) relates to a powdered sugar for confectionery products and is comprising fructose and isomaltulose.

JP 1987-0215244 (abstract) describes a sport's drink which is comprising isomaltulose and fruit juice.

JP 1986-0256738 (abstract) relates to special food and drink used for diabetics and is containing isomaltulose as sweetener.

U.S. Pat. No. 4,572,916 relates to tablets containing isomaltulose. Mixtures of isomaltulose and sucrose or saccharin are disclosed as well.

U.S. Pat. No. 4,587,119 relates to a method for reducing dental plaque formation by using isomaltulose as a whole or partial replacement for sucrose.

JP2001-069941 relates to a composition comprising fructose and trehalose in a ratio of 1:(0.4 to 1.0).

JP1999-0073019 relates to a sweetening agent which is comprising alpha-glucosyl stevia extract and trehalose.

JP1999-0074910 relates to a coffee drink wherein 10-30% of the sweetener is replaced with trehalose.

WO 00/70966 relates to edible compositions containing trehalose.

WO 01/17503 relates to sugar compositions comprising trehalose and sucrose.

GB 2 356 788 relates to the use of trehalose for the preparation of nutritional compositions for consumption during or shortly before physical exercise.

WO 96/08979 provides isotonic or hypotonic sports beverages which supply a readily metabolized, natural carbohydrate, trehalose.

WO 01/39615 relates to the use of trehalose for the preparation of a nutritional composition. A sports drink comprising trehalose, aspartame and acesulfame is disclosed.

EP 0 882 408 describes a method to add 2-12% trehalose to sucrose.

EP 0850 947 relates to a crystalline powdery saccharide obtainable by crystallizing trehalose along with a different saccharide selected from the group consisting of glucose, maltose, sorbitol and maltitol.

There is a further need for having compositions suitable for sustained carbohydrate energy release.

The current invention provides such a composition and products comprising this composition.

### SUMMARY OF INVENTION

The current invention relates to a dry composition comprising isomaltulose, at least one polyol and a carbohydrate (H) selected from the group consisting of fructose, sucrose, invert sugar, and mixtures thereof. It further relates to a dry composition, which is further comprising at least one intense sweetener.

The current invention relates to said composition wherein the weight ratio of isomaltulose to said carbohydrate (H) is from 20:80 to 70:30, preferably the weight ratio of isomaltulose to said carbohydrate (H) is from 30:70 to 60:40.

The current invention further relates to a liquid blend comprising a liquid and said dry composition according to the current invention. Said blend is further comprising a fructose syrup.

Furthermore, the current invention relates to a solid or semi-solid comestible characterized in that said comestible is comprising edible ingredients and at least 5% of dry substance of said comestible is a dry composition according to the current invention. It further relates to a liquid comestible characterized in that it is comprising
a) Edible ingredients and said liquid blend and optionally an edible liquid, or
b) an edible liquid and a solid or semi-solid comestible according to the current invention. Said comestible is selected from the group consisting of tablets, bars, confectionery, beverages, beverage concentrates, gels, drink powders, diabetic food, baby food, infant food, dietetic food, slimming food, food for special dietary needs, and medical food.

The current invention relates to a beverage which is selected from the group consisting of hypotonic beverages, soft drinks, sports drinks, hypertonic beverages, energy drinks, and isotonic beverages. Said beverage is comprising further carbohydrates, proteins, peptides, amino acids, antioxidants, fats, vitamins, trace elements, electrolytes, intense sweeteners, edible acids, flavors and/or mixtures thereof.

Said further carbohydrates are selected from the group consisting of monosaccharides, disaccharides, gelling starches, starch hydrolysates, dextrins, fibers, polyols and mixtures thereof.

The current invention relates to a beverage wherein at least 50% of the dry substance of said beverage is a dry composition according to current invention. It further relates to a beverage wherein at least 80%, preferably at least 90%, more preferably at least 95% of the dry substance of said beverage is a dry composition according to current invention.

The current invention relates to an isotonic beverage that it is comprising isomaltulose, at least one polyol and a carbohydrate (H) selected from the group consisting of fructose, sucrose, invert sugar, and mixtures thereof and the weight ratio of isomaltulose to said carbohydrate (A) is from 20:80 to 70:30.

Furthermore, the current invention relates to a method of preserving osmolality of a beverage, preferably an isotonic beverage by replacing 20 to 90%, preferably 30 to 80% by weight of sucrose with trehalose or isomaltulose. It further relates to a method wherein at least one intense sweetener is added and/or a polyol or a mixture of polyols is added. The current invention relates to a method wherein the osmolality is preserved for at least one month at ambient temperature, preferably for at least 3 months.

The current invention relates to the use of
a) isomaltulose
b) trehalose, or
c) mixture of trehalose and isomaltulose
   for manufacture of athletics food, dietetic food, food for special dietary needs, slimming food, diabetics food, baby food, infant food and food for elderly, and medical food for increasing fat oxidation.

The current invention further relates to the use of
a) a mixture (A) of isomaltulose and sweet energy source selected from the group consisting of fructose, sucrose, invert sugar, polyol, intense sweetener, and mixtures thereof,
b) a mixture (B) of trehalose and sweet energy source selected from the group consisting of fructose, sucrose, invert sugar, polyol, intense sweetener, and mixtures thereof, or
c) a mixture (C) of isomaltulose, trehalose and sweet energy source selected from the group consisting of fructose, sucrose, invert sugar, polyol, intense sweetener, and mixtures thereof,
   for manufacture of athletics food, dietetic food, food for special dietary needs, slimming food, diabetics food, baby food, infant food and food for elderly, and medical food for increasing fat oxidation.

Furthermore, the current invention relates to the use of
a) a mixture (A) of isomaltulose and sweet energy source selected from the group consisting of fructose, sucrose, invert sugar, polyol, intense sweetener, and mixtures thereof, or
b) a mixture (B) of trehalose and sweet energy source selected from the group consisting of fructose, sucrose, invert sugar, polyol, intense sweetener, and mixtures thereof,
   for the manufacture of athletics food, dietetic food, food for special dietary needs, slimming food, diabetics food, baby food, infant food and food for elderly, and medical food for sustained energy release. Additional, the current invention relates to the use wherein the sustained energy release is provided by increased fat oxidation.

The current invention relates to the use of
a) a mixture (A) of isomaltulose and sweet energy source selected from the group consisting of fructose, sucrose, invert sugar, polyol, intense sweetener, and mixtures thereof, or
b) a mixture (B) of trehalose and sweet energy source selected from the group consisting of fructose, sucrose, invert sugar, polyol, intense sweetener, and mixtures thereof,
   for the manufacture of comestible that modify perception of satiety or hunger.

Furthermore, the current invention relates to the use of
a) a mixture (D) of isomaltulose and trehalose,
b) isomaltulose, trehalose, at least one intense sweetener and/or carbohydrate (J) selected from the group consisting of fructose, sucrose, invert sugar, polyol and mixtures thereof,
   for the manufacture of athletics food, dietetic food, food for special dietary needs, slimming food, diabetics food, baby food, infant food and food for elderly, and medical food to reduction of digestive discomfort.

### DETAILED INVENTION

The current invention relates to a dry composition comprising isomaltulose, at least one polyol and a carbohydrate (H) selected from the group consisting of fructose, sucrose, invert sugar, and mixtures thereof. It further relates to a dry composition, which is further comprising at least one intense sweetener.

The current invention relates to said composition wherein the weight ratio of isomaltulose to said carbohydrate (H) is from 20:80 to 70:30, preferably the weight ratio of isomaltulose to said carbohydrate (H) is from 30:70 to 60:40.

Isomaltulose or 6-O-α-D-glucopyranosyl-D-fructofuranose is synthesised from sucrose by the action of an enzyme present in bacterial strains like Protaininobacter rubrum, Erwinia rhapontici and Serratia plymuthica.

The polyol can be described as a hydrogenated carbohydrate and is fulfilling the general formula CₙH₂ₙ₊₂O_{n,}although some of the polyols can be prepared according to a fermentation process and have nothing to do with hydrogenation of carbohydrates. In general the polyol is selected from the group consisting of tetritols, pentitols, hexitols, and higher polyols. The polyol is including but not limited to erythritol, xylitol, arabinitol, sorbitol, mannitol, iditol, galactitol, maltitol, isomaltitol, isomalt, lactitol, mixtures thereof and the like.

The ratio of isomaltulose to polyol is such that no digestive discomfort, and/or diarrhea are induced.

An intense sweetener, which can be used as non-nutritive sweetener can be selected from the group consisting of aspartame, acesulfame salts such as acesulfame-K, saccharins (e.g. sodium and calcium salts), cyclamates (e.g. sodium and calcium salts), sucralose, alitame, neotame, steviosides, glycyrrhizin, neohesperidin dihydrochalcone, monatin, monellin, thaumatin, brazzein and mixtures thereof.

The composition is particular useful for providing carbohydrate energy over a long period, while the composition is digestible and absorbable.

The current invention further relates to a liquid blend comprising a liquid and said dry composition according to the current invention. Said blend is further comprising a fructose syrup.

Fructose syrups cover all syrups which are containing on dry substance from 42 to 100% fructose. An example of such a fructose syrup can be high fructose corn syrup which is containing from 42-55% fructose.

Furthermore, the current invention relates to a solid or semi-solid comestible characterized in that said comestible is comprising edible ingredients and at least 5% of dry substance of said comestible is a dry composition according to the current invention. It further relates to a liquid comestible characterized in that it is comprising
a) Edible ingredients and said liquid blend and optionally an edible liquid, or
b) an edible liquid and a solid or semi-solid comestible according to the current invention.

For obtaining the liquid comestible the liquid blend of the current invention is applied and optional an edible liquid, or the dry composition of the current invention is mixed with an edible polar liquid, preferably a water containing liquid, more preferably water. Actually the mix of the dry composition, the liquid blend and optionally an edible liquid is also part of the current invention.

Said comestible is selected from the group consisting of tablets, bars, confectionery, beverages, beverage concentrates, gels, drink powders, diabetic food, baby food, infant food, dietetic food, slimming food, food for special dietary needs, and medical food.

Tablets can be based solely upon the dry composition of the current invention. Lubricants such as magnesium stearate, calcium stearate, stearic acid, sucrose fatty acid esters, and/or talc and the like can be added according to needs.

The diabetic food, baby food, infant food, dietetic food, slimming food, food for special dietary needs refer respectively to any type of food suitable for diabetics, babies, infants and people needing a special dietetic formulation and any one who can benefit from the presence of a sustained carbohydrate energy release source, and those who can benefit from a modified perception of satiety or hunger.

Medical food refer to any liquid, semi-solid or liquid comestible which is given to people in medical need for having access to extra sustained carbohydrate energy source, e.g. people with heavy burns and/or scalds.

The current invention relates to a beverage which is selected from the group consisting of hypotonic beverages, soft drinks, sports drinks, hypertonic beverages, energy drinks, and isotonic beverages.

The beverage can be any medical syrup or any drinkable solution including iced tea, and fruit juices, vegetable based juices, lemonades, cordials, nut based drinks, cocoa based drinks, dairy products such as milk, whey, yogurts and drinks based on them.

Beverage concentrate refers to a concentrate that is either in liquid form or in essentially dry mixture form. The liquid concentrate can be in the form of a relatively thick, syrupy liquid. The essentially dry mixture can be in the form of either a powder or a tablet. The beverage concentrate is usually formulated to provide a drinkable beverage composition or a final beverage when constituted or diluted with water, either carbonated or non-carbonated.

Drink powders are suitable for constituting with water, carbonated or non-carbonated, a final beverage for oral administration.

A specific example of a hypotonic beverage is a rehydration drink.

In general, the beverage can further be characterized in having an osmolality of from 50 to 800 mOs/kg, preferably from 150 to 600 mOs/kg, more preferably from 200 to 400 mOs/kg.

An isotonic beverage is typically characterized by an osmolality of from 270-330 mOs/kg.

Said beverage is comprising further carbohydrates, proteins, peptides, amino acids, antioxidants, fats, vitamins, trace elements, electrolytes, intense sweeteners, edible acids, flavors and/or mixtures thereof.

Said further carbohydrates are selected from the group consisting of monosaccharides, disaccharides, gelling starches, starch hydrolysates, dextrins, fibers, polyols and mixtures thereof and whereby these carbohydrates are different from isomaltulose, trehalose and carbohydrate (H) as mentioned in the composition of current invention.

The monosaccharides include tetroses, pentoses, hexoses and ketohexoses.

Typical disaccharides include sucrose, maltose, trehalulose, melibiose, kojibiose, sophorose, laminaribiose, isomaltose, gentiobiose, cellobiose, mannobiose, lactose, leucrose, maltulose, turanose and the like.

Starch hydrolysates are produced by the controlled acid or enzymatic hydrolysis of starch and can be subdivided into two specific categories, maltodextrins and glucose syrups and are characterized by DE number (dextrose equivalent). In fact, DE number is a measurement of the percentage of reducing sugars present in the syrup and calculated as dextrose on a dry weight basis. Maltodextrins have a DE number up to 20 whereas glucose syrups have an DE number greater than 20.

Dextrins are prepared according to the dextrinisation method. Dextrinisation is a heat treatment of dry starch in presence or absence of acid.

Gelly starches may include emulsified starches such as starch n-octenyl succinate.

The low-calorie fibers can be polydextrose, arabinogalactan, chitosan, chitin, xanthan, pectin, cellulosics, konjac, gum Arabic, soy fiber, inulin, modified starch, hydrolysed guar, guar gum, beta-glucan, carageenan, locust bean gum, alginate, polyglycol alginate.

Among the vitamins one can range vitamin A, vitamin C, vitamin E, vitamin B₁₂, and the like.

The edible acids can be selected from phosphoric acid, citric acid, malic acid, succinic acid, adipic acid, gluconic acid, tartaric acid, fumaric acid and mixtures thereof Preferably the pH range of the beverage is from about 2 to about 6.5.

The flavors are selected from fruit flavors, botanical flavors and mixtures thereof. Preferred flavors are cola flavor, grape flavor, cherry flavor, apple flavor and citrus flavors such as orange flavor, lemon flavor, lime flavor, fruit punch and mixtures thereof. The amount of flavor depends upon the flavor or flavors selected, the flavor impression desired and the form of flavor used.

If desired, coloring agents can also be added. Any water-soluble coloring agent approved for food use can be utilized for the current invention.

When desired, preservatives such as potassium sorbate and sodium benzoate can be added.

Gums, emulsifiers and oils can also be added in the beverage for texture and opacity purposes. Typical ingredients include carboxymethylcellulose, mono-di-glcerides, lecithin, pulp, cotton seed oil and vegetable oil. It further can comprise foam stabilizing agents such as yucca, or yucca/quillaia extracts.

The current invention relates to a beverage wherein at least 50% of the dry substance of said beverage is a dry composition according to current invention. It further relates to a beverage wherein at least 80%, preferably at least 90%, more preferably at least 95% of the dry substance of said beverage is a dry composition according to current invention.

The current invention relates to an isotonic beverage that it is comprising isomaltulose, at least one polyol and a carbohydrate (H) selected from the group consisting of fructose, sucrose, invert sugar, and mixtures thereof and the weight ratio of isomaltulose to said carbohydrate (H) is from 20:80 to 70:30.

The beverage may be prepared by mixing together all of the ingredients. The mixture is then dissolved in water and agitated until all the ingredients are dissolved. Dissolution may occur at ambient temperature but it may be necessary for the solution to be heated to temperature between 50-100° C. to get all the ingredients into solution. After the mixture having been adjusted to a desired pH, the beverage may be bottled, capped, and eventually pasteurized at about 75° C. for about 20 minutes, or the beverage may be before bottling continuously pasteurized for a few minutes.

One way to prepare the concentrate of the beverage would be to start with less than the required volume of the liquid solvent that is used to prepare the drinkable beverage. Another way would be to partially dehydrate the finally prepared drinkable beverage to remove only a portion of the liquid solvent and any other volatile liquid present.

Carbon dioxide can be introduced either into the water to be mixed with the beverage concentrate or into the drinkable beverage to achieve carbonation. The carbonated beverage can then be stored in a container, such as a bottle or a can, and is then sealed.

Furthermore, the current invention relates to a method of preserving (=sustaining) osmolality of a beverage, preferably an isotonic beverage by replacing 20 to 90%, preferably 30 to 80% by weight of sucrose with trehalose or isomaltulose. It further relates to a method wherein at least one intense sweetener is added and/or a polyol or a mixture of polyols is added. The current invention relates to a method wherein the osmolality is preserved for at least one month at ambient temperature, preferably for at least 3 months.

Osmolality is a count of the total number of osmotically active particles in a solution and is equal to the sum of the molalities (molality is the number of particles in a mass weight of fluid (mmol/kg)) of all the solutes present in that solution.

In an isotonic beverage the concentration of the carbohydrates is such that the osmolality (expressed in mOs/kg) is the same or is only marginally exceeding the tonicity (=measure of the osmotic pressure of a solution relative to the osmotic pressure of the blood fluids) of the blood. The osmolality of blood usually ranges from about 280 to 310 mOs/kg. The osmolality can be measured with an osmometer, which is a device measuring the osmotic pressure (for example measuring the osmolality by the freezing-point method).

The method of the current invention is particular useful for beverages at pH below 7, preferably at pH between 3 and 4, more preferably for beverages at pH between 2 and 3.

Surprisingly, it was found that by replacing sucrose completely or partially with a composition comprising isomaltulose or trehalose in a beverage, preferably an isotonic beverage, the osmolality is constant under acid conditions and the osmolality remains over time more constant then in isotonic beverages based upon sucrose as carbohydrate source. Actually due to the more stable osmolality, a higher amount of the composition comprising isomaltulose or trehalose can be added to the beverage and yet the tonicity is not increasing at acidic pH, and consequently a higher amount of energy can be provided, over a longer period.

The current invention relates to a method wherein the osmolality is preserved for at least one month at ambient temperature, preferably for at least 3 months and more preferably for a period of at least one year.

The current invention relates to the use of
a) isomaltulose,
b) trehalose, or
c) mixture of isomaltulose and trehalose
   for the manufacture of athletics food, dietetic food, food for special dietary needs, slimming food, diabetics food, baby food, infant food and food for elderly, and medical food for increasing fat oxidation.

It is surprisingly found that by using a food containing isomaltulose, trehalose or a mixture of both, the fat oxidation is induced. In the mixture of trehalose and isomaltulose the weight ratio can vary from 90:10 to 10:90, 80:20 to 20:80, 70:30 to 30:70, 60:40 to 40:60, and 50:50. This is of particular interest for people who are interested in burning fat, slimming food, and people on a diet to loose weight. This use is also of interest for people doing exercise who besides the energy from carbohydrates can benefit from the energy available from fat oxidation.

The current invention further relates to the use of
a) a mixture (A) of isomaltulose and sweet energy source selected from the group consisting of fructose, sucrose, invert sugar, polyol, intense sweetener, and mixtures thereof,
b) a mixture (B) of trehalose and sweet energy source selected from the group consisting of fructose, sucrose, invert sugar, polyol, intense sweetener, and mixtures thereof, or
c) a mixture (C) of isomaltulose, trehalose and sweet energy source selected from the group consisting of fructose, sucrose, invert sugar, polyol, intense sweetener, and mixtures thereof,
   for increasing fat oxidation of athletics food, dietetic food, food for special dietary needs, slimming food, diabetics food, baby food, infant food and food for elderly, and medical food.

It relates to the use of
a) a mixture (A) of isomaltulose and sweet energy source selected from the group consisting of fructose, sucrose, invert sugar, polyol, intense sweetener, and mixtures thereof,
b) a mixture (B) of trehalose and sweet energy source selected from the group consisting of fructose, sucrose, invert sugar, polyol, intense sweetener, and mixtures thereof, or
c) a mixture (C) of isomaltulose, trehalose and sweet energy source selected from the group consisting of fructose, sucrose, invert sugar, polyol, intense sweetener, and mixtures thereof,
   for the manufacture of athletics food, dietetic food, food for special dietary needs, slimming food, diabetics food, baby food, infant food and food for elderly, and medical food for increasing fat oxidation.

Furthermore, the current invention relates to the use of
a) a mixture (A) of isomaltulose and sweet energy source selected from the group consisting of fructose, sucrose, invert sugar, polyol, intense sweetener, and mixtures thereof, or
b) a mixture (B) of trehalose and sweet energy source selected from the group consisting of fructose, sucrose, invert sugar, polyol, intense sweetener, and mixtures thereof,
   for sustained energy release of athletics food, dietetic food, food for special dietary needs, slimming food, diabetics food, baby food, infant food and food for elderly, and medical food.

Actually the current invention relates to the use of
a) a mixture (A) of isomaltulose and sweet energy source selected from the group consisting of fructose, sucrose, invert sugar, polyol, intense sweetener, and mixtures thereof, or
b) a mixture (B) of trehalose and sweet energy source selected from the group consisting of fructose, sucrose, invert sugar, polyol, intense sweetener, and mixtures thereof,
   for the manufacture of athletics food, dietetic food, food for special dietary needs, slimming food, diabetics food, baby food, infant food and food for elderly, and medical food for sustained energy release.

Additional, the current invention relates to the use wherein the sustained energy release is provided by increased fat oxidation.

The current invention relates to the use of
a) a mixture (A) of isomaltulose and sweet energy source selected from the group consisting of fructose, sucrose, invert sugar, polyol, intense sweetener, and mixtures thereof, or
b) a mixture (B) of trehalose and sweet energy source selected from the group consisting of fructose, sucrose, invert sugar, polyol, intense sweetener, and mixtures thereof,
   to modify perception of satiety or hunger.

Specifically it relates to the use of
a) a mixture (A) of isomaltulose and sweet energy source selected from the group consisting of fructose, sucrose, invert sugar, polyol, intense sweetener, and mixtures thereof, or
b) a mixture (B) of trehalose and sweet energy source selected from the group consisting of fructose, sucrose, invert sugar, polyol, intense sweetener, and mixtures thereof, to manufacture comestibles that modify perception of satiety or hunger. The modified perception of satiety or hunger can be further induced by the
   additional effect that isomaltulose, trehalose and mixtures thereof have on the subsequently induced fat oxidation.

Furthermore, the current invention relates to the use of
a) a mixture (D) of isomaltulose and trehalose,
b) isomaltulose, trehalose, at least one intense sweetener and/or carbohydrate (3) selected from the group consisting of fructose, sucrose, invert sugar, polyol and mixtures thereof,
   for reduction of digestive discomfort of athletics food, dietetic food, food for special dietary needs, slimming food, diabetics food, baby food, infant food and food for elderly, and medical food.

The current invention relates to the use of
a) a mixture (D) of isomaltulose and trehalose,
b) isomaltulose, trehalose, at least one intense sweetener and/or carbohydrate (J) selected from the group consisting of fructose, sucrose, invert sugar, polyol and mixtures thereof, for the manufacture of athletics food, dietetic food, food for special dietary needs,
   slimming food, diabetics food, baby food, infant food and food for elderly, and medical food for reduction of digestive discomfort.

Some people might suffer from digestive discomfort when consuming too high quantities of isomaltulose or trehalose and consequently the energy supply is limited by the risk of digestive discomfort. This negative aspect is completely nullified by consuming mixtures of isomaltulose and trehalose.

It is noticed that people can consume larger quantities of foods containing isomaltulose and trehalose without suffering from digestive discomfort. By using thewse mixtures higher quantities of the single compounds can be consumed and consequently the direct energy supply from the carbohydrates is increased and further energy becomes available by the boosted fat oxidation.

The current invention has the following advantages:
The composition comprising isomaltulose, at least one polyol and carbohydrate (H) selected from the group consisting of fructose, sucrose, invert sugar, and mixtures thereof is a suitable source of sustained carbohydrate energy release and can be applied in solid, semi-solid and liquid comestibles.
The comestible is suitable for athletics, diabetics, babies, infants, elderly people and those requiring a special diet in respect of sustained carbohydrate energy release.
The comestible is suitable for people following a slimming diet due to the modified perception of satiety or hunger.
The osmolality of beverages, in particular isotonic beverages is kept constant by applying isomaltulose or trehalose.
Isomaltulose, trehalose or mixtures thereof induce fat oxidation
Due to the increase in plasma free fatty acids and the increased total fat oxidation isomaltulose as well as trehalose or mixtures thereof can be used as weight loss booster.
Isomaltulose, trehalose and mixtures thereof can be used to support weight maintenance.
Mixtures of isomaltulose and trehalose provide energy in higher quantities compared to the single compounds because of the reduction of the risk of any digestive discomfort.

The current invention is illustrated by way of the following examples.

### EXAMPLE 1

The basic syrup was prepared with the following ingredients:
202 g isomaltulose
389 g fructose
5 ml sodium benzoate 10% (w/v)
3 ml phosphoric acid 85%
15 g cola flavor Wild (nr 35103000170000)
carbonated water was added for obtaining 1 liter basic syrup.

42 ml of this basic syrup was placed in a bottle and further diluted with carbonated water to a final volume of 210 ml.

The taste was evaluated with a taste panel.

A good cola perception was found, comparable to a standard drink prepared with 534 g sucrose.

### EXAMPLE 2

The basic syrup was prepared with:
306 g isomaltulose
290 g fructose
5 ml sodium benzoate 10% (w/v)
2.6 ml phosphoric acid 85%
15 cola flavor Wild (nr 35103000170000)
+carbonated water until 1 Liter

42 ml of this basic syrup was diluted with carbonated water until a final volume of 210 ml.

The taste was again evaluated by a taste panel and was considered as an acceptable formulation.

### EXAMPLE 3

The basic syrup was prepared with the following ingredients:
210 g trehalose dihydrate
385 g sucrose
5 ml sodium benzoate 10% (w/v)
2.6 ml phosphoric acid 85%
15 g cola flavor Wild (nr 35103000170000)
carbonated water was added for obtaining 1 liter basic syrup.

42 ml of this basic syrup was placed in a bottle and further diluted with carbonated water to a final volume of 210 ml.

The taste was evaluated with a taste panel.

A good cola perception was found, comparable to a standard drink prepared with 534 g sucrose.

### EXAMPLE 4

The basic syrup was prepared with:
319 g trehalose dihydrate
288 g sucrose
5 ml sodium benzoate 10% (w/v)
2.6 ml phosphoric acid 85%
15 cola flavor Wild (nr 35103000170000)
+carbonated water until 1 Liter

42 ml of this basic syrup was diluted with carbonated water until a final volume of 210 ml.

The taste was again evaluated by a taste panel and was considered as an acceptable formulation.

### EXAMPLE 5

An isotonic drink was prepared with isomaltulose and sucrose according to the following recipe:
65 g sucrose
111.87 g isomaltulose
1.52 g sodium chloride
0.75 g citric acid monohydrate
4.2 g orange flavor Wild
3 ml sodium benzoate 10% (w/v) Add Spa™ water to make 2 liter of drink.

The isotonic drink had an osmolality of 310 mOsmol/kg

The taste was evaluated by taste panel and it was perceived as having an acceptable flavor and no off-taste was observed.

The osmolality can be measured after 1 and 3 months storage and the value of the osmolality is not changing over time.

### EXAMPLE 6

An isotonic drink was prepared with trehalose and sucrose according to the following recipe:
65 g sucrose
116.41 g trehalose dihydrate
1.52 g sodium chloride
0.75 g citric acid monohydrate
4.2 g orange flavor Wild
3 ml sodium benzoate 10% (w/v)
Add Spa™ water to make 2 liter of drink.

The isotonic drink had an osmolality of 308 mOsmol/kg

The taste was evaluated by taste panel and it was perceived as having an acceptable flavor and no off-taste was observed.

The osmolality can be measured after 1 and 3 months storage and the value of the osmolality is not changing over time.

### EXAMPLE 7

The effect of isomaltulose on metabolic fate during endurance exercise (C13) was measured and was compared with mean ingestion of sucrose. Ten healthy, moderately trained men were recruited in this study. The subjects were all club/country standard endurance athletes with a training background of at least 3 years. The subjects characteristics were: age: 27±2 yrs, body mass: 74.7±2.5 kg, BMI 23.0±0.9 kg/m², VO₂max: 62.7±1.1 ml/kg/min. 5 to 7 days prior to each experimental testing day, they were asked to perform an intense training session (‘glycogen depleting’ exercise bout) in an attempt to empty any ¹³C-enriched glycogen stores. Subjects were further instructed not to consume any food products with a high natural abundance of ¹³C at least 1 week before and during the entire experimental period in order to minimize the background shift (change in ¹³CO₂) from endogenous substrate stores. Subjects were asked to visit the laboratory on three different occasions after a 10-12 h overnight fast. During each visit, subjects were asked to cycle for 150 min at 50% of their maximal work rate (Wmax). During each test the subjects received a drink containing water (WAT), sucrose (SUC) or isomaltulose (ISO), the latter two containing carbohydrates with a naturally high ¹³C abundance. During the test, expired gas analyses were performed and breath and blood samples were collected at regular intervals. The enrichment of the breath samples was used to calculate exogenous carbohydrate oxidation. The tests were performed 7 days apart and the order of the tests was randomly assigned in a crossover design. Upon arrival to the laboratory, body mass (Seca Alpha, Germany) and height were recorded. Subjects started cycling at 95 W and the work rate was increased by 35 W every 3 min until exhaustion. Heart rate was recorded continuously during the test using a radio telemetry heart rate monitor (Polar Vantage NV, Polar Electro Oy, Finland). Breath-by-breath measurements were performed throughout exercise using an online gas analysis system (Oxycon Pro, Jaeger, Wuerzberg, Germany). The flow sensor and gas analyzers of the system were calibrated using a 3-litre calibration pump and calibration gas (15.12% O₂; 5.10% CO₂), respectively. Wmax was calculated from the last completed work rate, plus the fraction of time spent in the final non-completed work rate multiplied by the work rate increment. After arrival in the laboratory, a Teflon catheter (Quickcath, Baxter, Norfolk, UK) was introduced into an antecubital arm vein and connected to a 3-way stopcock (Sims Portex, Kent, UK). The catheter was maintained patent with isotonic saline (Baxter, Norfolk, UK). Before the start of the experiment, resting breath samples were collected in exetainers (Labco Ltd. Brow works, High Wycombe, UK) from a mixing chamber to determine the ¹³C/¹²C ratio in expired air. In addition, a blood sample was collected after which the subjects consumed a 600 ml bolus of either water or one the 8.5% CHO (carbohydrate containing) drinks. The drinks consisted of 165 g of carbohydrate (1.1 g CHO/min), dissolved in water up to a volume of 1950 ml. 2.28 g of sodiumchloride was added to create a 20 mM solution. After consumption of the bolus the subjects started cycling at 50% Wmax, an intensity which elicited 58.8±1.9% VO₂max. During exercise the subjects were provided with 150 ml of the experimental drink every 15 min. Blood and breath samples were collected at 15 min intervals and expired gas analysis was performed for four minutes at the end of each 15 min interval. From indirect calorimetry (VO₂and VCO₂), stable isotope measurements (breath ¹³CO₂/¹²CO₂ ratio), oxidation rates of total fat, total CHO (carbohydrate) and exogenous sucrose or isomaltulose were calculated. From VO₂ and VCO₂ (L/min), fat oxidation rates were calculated using stoichiometric equation:
Fat oxidation=1.67 VO₂−1.67 VCO₂

Experimental data are expressed as means ±SEM. Before statistical analysis, the variables were tested for normality at all time-points. A two-way general linear model for repeated measures (intensity ×time) was used to identify differences between the three different trials. In the event that the sphericity was violated, the analyses were adjusted using a Greenhouse-Geisser correction. When a significant F-ratio was obtained, the

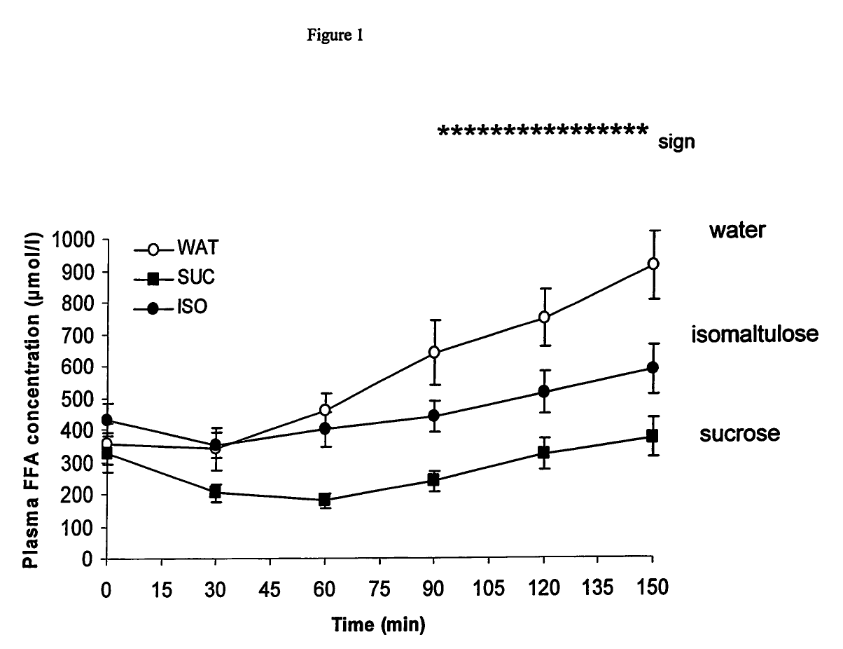

Tukey post-hoc test was used to locate the differences. For all statistical analyses, significance was accepted at p<0.05. The result is displayed in FIG. 1. Plasma fatty acid concentration rose significantly above fasting levels in the WAT trial after 90 min of exercise (FIG. 8). The concentration rose marginally during ISO trial and only after 2.5 hours of cycling the concentration rose above fasting levels. A significant decrease in the FFA concentration was seen after 60 min in the SUC trial after which the concentration increased towards fasting levels. The FFA concentration was significantly higher during the WAR and ISO compared to the SUC trial.

### EXAMPLE 8

The effect of trehalose on metabolic fate during endurance exercise (C13) was measured and was compared with mean ingestion of maltose. Nine trained male cyclists of triathletes aged of 28±5 years, with a body mass of 75.5±7.4 kg, a height of 181±6 cm, a maximal oxygen uptake (VO₂ max) 64.5±4.9 ml/kg⁻¹/min⁻¹, and a maximal power output (Wmax) 4.9±0.5 W/kg⁻¹ v (mean±SD) participated in the study. All subjects completed three exercise trials, which were randomly assigned and separated by at least one week. Each trial of cycling for 150 min at 55% Wmax whilst ingesting either an 8.5% maltose (MAL) or trehalose (TRE) solution or water (WAT). The drinks consisted of 165 g of carbohydrate (1.1 g CHO/ min⁻¹) dissolved in water up to a volume of 1950 ml/2.28 g of sodium-chloride was added to create a 20 mM solution. On arrival a 21-gauge Teflon catheter (Quickcath, Baxter, Norfolk, UK) was inserted in an antecubial vein and attached to a 3-way stopcock (Sims Portex, Kingsmead, UK) for blood sampling. The catheter was kept patent by flushing with 1.0 to 1.5 ml of isotonic saline (0.9% Baxter, Norfolk, UK) after each sample collection.

After voiding the subject was weighed in cycling shorts to the nearest 0.1 kg on platform scales (Seca Alpha, Hamburg, Germany). The subjects then mounted the cycle ergometer and duplicate resting breath sample were collected directly from a mixing chamber into 10 ml Exetainer tubes (Labco Limited, Brow Works, High Wycombe, UK). A resting blood sample was collected into a 10 ml vacutainer (Becton Dickinson, HMS, UK) stored on ice and later centrifuged. Additional blood and expiratory breath samples were collected at 15 min intervals throughout the exercise period. VO₂ and VCO₂ were measured every 15 min for periods of 5 min.

Approximately 30 min after catherisation, exercise at a workload of 55% Wmax was started. An initial bolus of 600 ml of one of the three experimental drinks; MAL, TRE or WAT was ingested. This was followed every 15 min by a beverage volume of 150 ml. This drinking schedule was chosen as it has been shown produce tracer steady states after 60 min of exercise. Immediately after exercise subjects voided and after towelling dry were re-weighed (Seca Alpha, Hamburg, Germany) in cycling shorts. From indirect calorimetry (VO₂ and VCO₂) and stable isotope measurements (breath ¹³CO_{2/}¹²CO₂ ratio), oxidation rates of total fat, total carbohydrate and exogenous MAL or TRE were calculated.

From the rate of CO₂ production, (L/min⁻¹,VCO₂) and VO₂, fat oxidation rates (g/min⁻¹) were calculated using stoichiometric equation:
Fat oxidation=1.67 VO₂−1.67 VCO₂

Analysis of variance (ANOVA) for repeated measures was used to compare differences in substrate utilization and in blood related parameters over time between the trials. A Tukey post hoc was applied in the event of a significant F-ratio. All data are reported as means±SE. Statisctical significance was set at p<00.5.

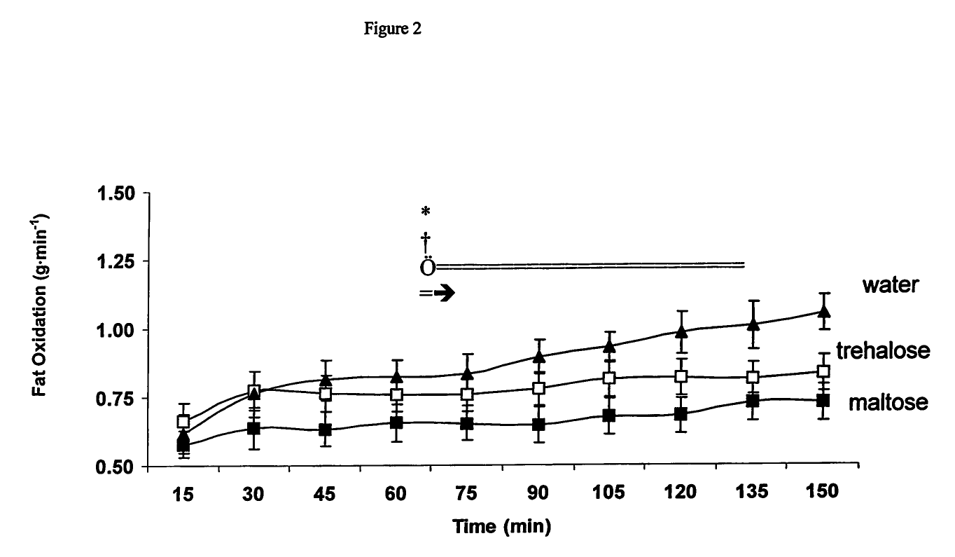

The result is displayed in FIG. 2.

Total fat oxidation became significantly increased from resting after 30 min in the WAT trial, 60 min in the TRE trial and during the final 30 min in the MAL trial. Therefore during the final 90 min of exercise fat oxidation was higher in the WAT trial than either of the carbohydrate trials, and concomitantly CHO (carbohydrate) oxidation was lower in the WAT trial.

1. A dry composition comprising isomaltulose, at least one polyol and a carbohydrate (H) selected from the group consisting of fructose, sucrose, invert sugar, and mixtures thereof.

2. A composition according to claim 1 characterized in that it is further comprising at least one intense sweetener.

3. A composition according to claim 1 characterized in that in said composition the weigh ratio of isomaltulose to said carbohydrate (H) is from 20:80 to 70:30.

4. A composition according to claim 1 characterized in that in said composition the weight ratio of isomaltulose to said carbohydrate (H) is from 30:70 to 60:40.

5. A liquid blend comprising a liquid and a dry composition according to claim 1.

6. A liquid blend according to claim 5 characterized in that said blend is further comprising a fructose syrup.

7. A solid or semisolid comestible characterized in that said comestible is comprising edible ingredients and at least 5% of dry substance of said comestible is a dry composition according to claim 1.

8. A liquid comestible characterized in that it is comprising:
a) edible ingredients and a liquid blend according to claim 5 and optionally an edible liquid, or
b) an edible liquid and a comestible according to claim 7.

9. A comestible according to claim 7 characterized in that said comestible is selected from the group consisting of tablets, bars, confectionery, beverages, beverage concentrates, gels, drink powders, diabetic food, baby food, infant food, dietetic food, slimming food, food for special dietary needs, and medical food.

10. A comestible according to claim 9 characterized in that said comestible beverage is selected from the group consisting of hypotonic beverages, soft drinks, sports drinks, hypertonic beverages, energy drinks, and isotonic beverages.

11. A beverage according to claim 10 characterized in that it further comprises carbohydrates, proteins, peptides, amino acids, antioxidants, fats, vitamins, trace elements, electrolytes, intense sweeteners, edible acids, flavors and/or mixtures thereof.

12. A beverage according to claim 11 characterized in that said further carbohydrates are selected from the group consisting of monosaccharides, disaccharides, gelling starches, starch hydrolysates, dextrins, fibers, polyols and mixtures thereof.

13. A beverage according to claim 10 characterized in that at least 50% of the dry substance of said beverage is a dry composition according to claim 1.

14. A beverage according to claim 10 characterized in that at least 80%, of the dry substance of said beverage is a dry composition of carbohydrates, proteins, peptides, amino acids, antioxidants, fats, vitamins, trace elements, electrolytes, intense sweeteners, edible acids, flavors and/or mixtures thereof.

15. A beverage according to claim 10 characterized in that said beverage is an isotonic beverage and that it is comprising isomaltulose, at least one polyol and a carbohydrate (H) selected from the group consisting of fructose, sucrose, invert sugar, and mixtures thereof and the weight ratio of isomaltulose to said carbohydrate (A) is from 20:80 to 70:30.

16. A method of preserving osmolality of a beverage, preferably an isotonic beverage by replacing 20 to 90%, of sucrose with trehalose or isomaltulose.

17. A method according to claim 16 characterized in that at least one intense sweetener is added.

18. A method according to claim 16 characterized in that a polyol or a mixture of polyols is added.

19. A method according to claim 16 characterized in that osmolality is preserved for at least one month at ambient temperature, preferably for at least 3 months.

20. Use of
a) isomaltulose,
b) trehalose, or
c) mixture of isomaltulose and trehalose,
for the manufacture for athletics food, dietetic food, food for special dietary needs, slimming food, diabetics food, baby food, infant food and food for elderly, and medical food for increasing fat oxidation.

21. Use according to claim 20 characterised in that a), b) or c) is enriched with a sweet energy source selected from the group consisting of fructose, sucrose, invert sugar, polyol, intense sweetener, and mixtures thereof.

22. Use of
a) a mixture (A) of isomaltulose and sweet energy source selected from the group consisting of fructose, sucrose, invert sugar, polyol, intense sweetener, and mixtures thereof, or
b) a mixture (B) of trehalose and sweet energy source selected from the group consisting of fructose, sucrose, invert sugar, polyol, intense sweetener, and mixture thereof,
for manufacture of athletics food, dietetic food, food for special dietary needs, slimming food, diabetics food, baby food, infant food and food for elderly, and medical food for sustained energy release.

23. Use according to claim 22 characterized in that sustained energy release is provided by increased fat oxidation.

24. Use of
a) a mixture (A) of isomaltulose and sweet energy source selected from the group consisting of fructose, sucrose, invert sugar, polyol, intense sweetener, and mixtures thereof, or
b) a mixture (B) of trehalose and sweet energy source selected from the group consisting of fructose, sucrose, invert sugar, polyol, intense sweetener, and mixture thereof,
to manufacture comestibles that modify perception of satiety or hunger.

25. Use of
a) a mixture (D) of isomaltulose and trehalose,
b) isomaltulose, trehalose, at least one intense sweetener and/or carbohydrate (J) selected from the group consisting of fructose, sucrose, invert sugar, polyol, intense sweetener, and mixture thereof,
for manufacture of athletics food, dietetic food, food for special dietary needs, slimming food, diabetics food, baby food, infant food and food for elderly, and medical food for reduction of digestive discomfort.
